(19) United States
(12) Patent Application Publication
(10) Pub. No.: US 2011/0197734 A1
(43) Pub. Date: Aug. 18, 2011

(54) Whirling cutting device

(75) Inventors: Hans-Joerg Braun, Hagen (DE); Klaus-Dieter Martin, Wetter (DE)

(73) Assignee: REIKA GMBH & CO. KG, Hagen (DE)

(21) Appl. No.: 12/931,726

(22) Filed: Feb. 9, 2011

(30) Foreign Application Priority Data
Feb. 16, 2010 (EP) 10001558.5

(51) Int. Cl. B23D 45/08

(52) U.S. Cl. 83/646

(57) ABSTRACT

A device for chip-producing machining of work pieces in the form of pipes and rods, using the whirling method has a whirling unit with a housing, on which an accommodation for a whirling tool with teeth on the inside is mounted so as to rotate. An electromagnetic rotational direct drive has a ring-shaped stator attached to the housing with an essentially U-shaped cross-section, and a rotor configured in the form of a ring-shaped crosspiece provided with permanent magnets, formed onto the accommodation. The rotor is mounted within the U-shaped cross-section of the stator, on the housing side. The stator has a winding for generation of an electromagnetic field, on its inside shank of its U-shaped cross-section that lies opposite the housing.

### CROSS REFERENCE TO RELATED APPLICATIONS

Applicants claim priority under 35 U.S.C. 119 of European Application No. EP 10001558.5 filed Feb. 16, 2010.

### BACKGROUND OF THE INVENTION

1. Field of the Invention

The invention relates to a device for chip-producing machining of work pieces in the form of pipes and rods, using the whirling method.

2. The Prior Art

The whirling method is a chip-removing method in which the tool circles around the work piece in the manner of a spiral whirl. The cutting depth is produced in a single work step, by means of one or more blades that revolve at a high cutting speed. In this connection, the inner mantle surface formed by the cutting tool rolls on the cylindrical outer mantle surface of the work piece to be machined. The constantly circulating movement of the cutting tool is superimposed on this movement process.

The whirling method, which is known, for example, from European Patent No. EP 0 490 328 B1, has the advantage that a plurality of cutting tools, particularly cutting steels, can be disposed next to one another, engaging the work piece at the same time, in the case of a larger segment range. During whirling cutting, a whirling saw tool with teeth that lie on the inside—subsumed in the concept of “saw blade” hereinafter—is used. The cutting teeth of the saw blade can penetrate into the work piece tangentially. Because of the whirling method, the effective penetration radius of the saw blade only has to comprise the wall thickness of the work piece. If this is a solid material, the saw blade only has to penetrate to the center point of the solid material, since the other half of the work piece is cut off by the revolution of the saw blade. Such whirling cutting devices are referred to as “circular saw” hereinafter.

Use of the whirling method for chip-producing machining of work pieces in the form of pipes and rods reduces machining times. The core part of the whirling device is the whirling unit, which has an accommodation for a whirling tool. This accommodation is mounted so as to rotate and is driven by a drive motor. For coupling of the drive motor to the accommodation, two embodiments, in particular, are used. For one thing, it is known to dispose the drive motor parallel to the axis of rotation of the accommodation, and to couple it with the accommodation with a belt drive. For this purpose, the electric motor must be dimensioned relatively large, so that the high torques and high speeds of rotation required for the whirling process can be made available. In this connection, the drive motor is frequently disposed on the side of the housing of the whirling unit, so that the whirling unit takes up a significant construction space. This is disadvantageous, particularly with regard to the pivoting angle of the whirling unit, which is frequently mounted at a slant, since the angle is restricted when the motor is disposed on the side. Furthermore, the belt drive is subject to mechanical wear, and this is accompanied by a loss in power with regard to the torque actually transferred. Furthermore, only unsatisfactorily smooth running can be achieved with the known belt drive.

Furthermore, it is known to dispose the drive motor so that it stands perpendicular to the axis of rotation of the accommodation with its drive shaft, and to couple it with the accommodation by way of a translation gear mechanism or conical gear mechanism. Here again, the drive motor must be dimensioned to be large, so that the required torques and speeds of rotation can be made available. This solution also requires significant construction space and furthermore proves to be very complicated with regard to the translation gear mechanism or conical gear mechanism to be used.

### SUMMARY OF THE INVENTION

It is therefore an object of the invention to provide a device for chip-producing machining of work pieces in the form of pipes and rods, in which the construction size of the whirling unit is minimized, in which power losses with regard to the actual torque transferred are avoided, and in which great air rest can be achieved.

This object is accomplished according to the invention by a device for chip-producing machining of work pieces in the form of pipes and rods, using the whirling method, in which the construction space of the whirling unit is minimized, and in which a power loss with regard to the actual torque transferred is avoided. By using an electromagnetic rotational direct drive, integration of the drive directly into the whirling unit is achieved. This direct drive acts directly together with the accommodation; transfer media such as toothed belts are not required. By forming the stator as a ring firmly affixed to the housing, and the configuration of the rotor as a crosspiece formed onto the accommodation, which is mounted within the U-shaped cross-section of the stator on the housing side, a very compact structure with a very small number of components is made possible. The windings of the stator are disposed over a large diameter on an inside shank of its U-shaped cross-section, lying opposite its housing. This large diameter makes a relatively large number of poles possible, while simultaneously maintaining the ability of the drive to withstand thermal stress. Since no mechanical transmission elements are present, great mechanical resistance to overload furthermore exists, thereby establishing great operational reliability. Because the bearings are disposed outside of the windings of the stator and separated by the air gap, there is only a slight heat transfer to the bearings.

In a further development of the invention, at least one channel for passing coolant through is disposed on the stator. In this way, better cooling of the winding is achieved, thereby making it possible to achieve better ability of the drive to withstand thermal stress, even in the case of a high-pole arrangement.

In an embodiment of the invention, at least one groove is made in the inside shank of the U-shaped cross-section of the stator, into which groove a guide crosspiece formed onto the accommodation engages. In this way, good guidance of the accommodation is brought about.

In a further embodiment of the invention, the rotor, formed in the form of a crosspiece formed onto the accommodation, is disposed essentially on the outer circumference of the accommodation. In this way, a transfer of torque in the immediate vicinity of the cutting body of the whirling tool accommodated by the accommodation is achieved. Undesirable moment stresses at the components that deflect the force flow are thereby avoided.

In a further embodiment of the invention, the stator has a projection directed in the direction of the axis of rotation of the accommodation on its side that faces the accommodation, which projection extends almost to the outside circumference of the accommodation. In this way, entrainment of foreign bodies between rotor and stator during operation is counteracted. Furthermore, such a projection can serve, at the same time, as a contact point for the bearings for mounting the rotor on the outside shank of the stator, on the housing side.

In a further development of the invention, the accommodation of the whirling unit comprises indexing pins that correspond to indexing bores present on the whirling tool. In this way, accommodation of the whirling tool in the accommodation, in the correct position, is made possible.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of a circular saw in a view from the rear; and

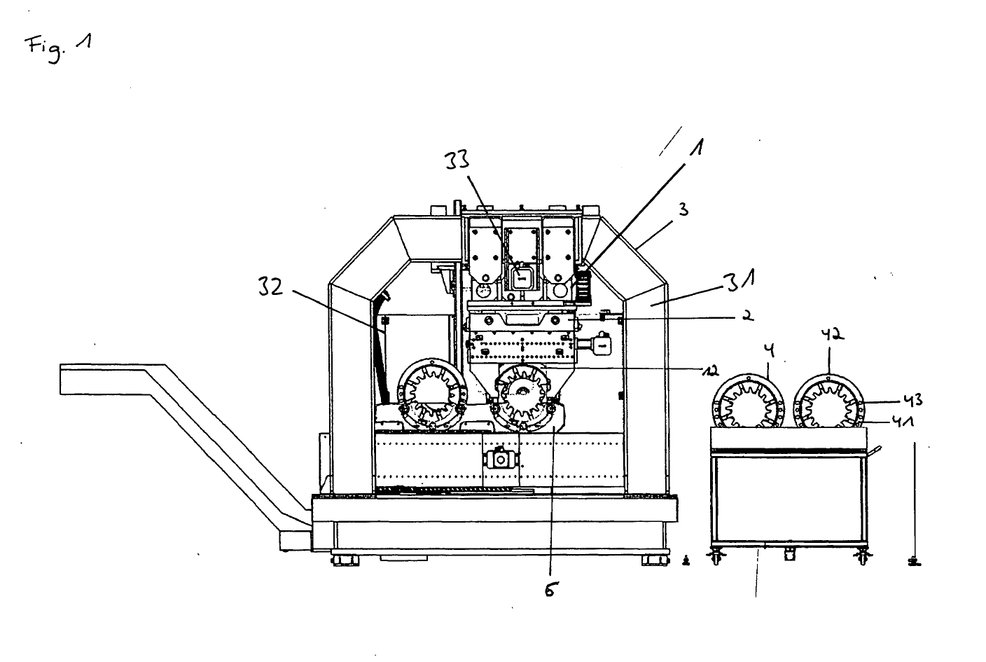

FIG. 2 shows a schematic representation of the electromagnetic rotational direct drive of the circular saw from FIG. 1.

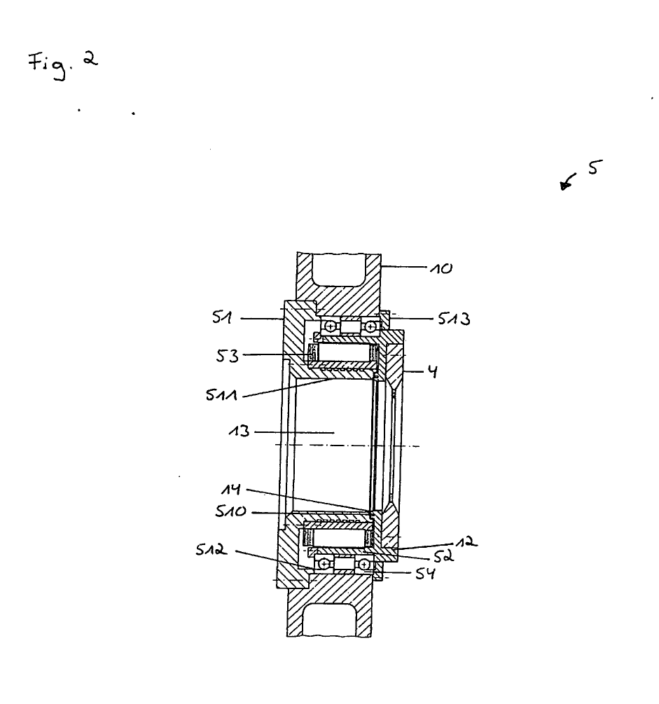

### DETAILED DESCRIPTION OF THE PREFERRED EMBODIMENT

Referring now in detail to the drawing, the whirling device selected as the exemplary embodiment is a whirling cutting device, referred to hereinafter as a circular saw. It comprises a whirling unit 1 disposed in a housing 10, having a work piece feed as well as a pick-up 2, which are disposed in a frame system 3. In this connection, frame system 3 is essentially formed from two portals 31, 32 disposed parallel to one another, which are connected with one another at the head side by way of a connection beam 33. In this connection, whirling unit 1 is attached to unit portal 31; support portal 32 serves as the bearing for connection beam 33. A rail is attached to connection beam 33, on which rail pick-up 2 is displaceably disposed. In the exemplary embodiment, the circular saw has an integrated tool change system 6.

Whirling unit 1 comprises a tool accommodation 12 for accommodating a saw blade 4. The tool accommodation 12 is configured essentially in funnel shape, thereby improving the removal of chips. Surrounding its circular opening, a contact flange for accurate-fit contact of a saw blade 4 is disposed in tool accommodation 12. For a defined position of saw blade 4 in tool accommodation 12, the contact flange is provided with an indexing pin—not shown—that can be introduced into an indexing bore 42 made in blade carrier ring 41.

Tool accommodation 12 is connected with an electromagnetic rotational direct drive 5. Direct drive 5 is essentially formed by a ring-shaped stator 51 affixed to housing 10 of whirling unit 1, which stator has an essentially U-shaped cross-section, and a rotor 52 that is formed in the form of a ring-shaped crosspiece, provided with a permanent magnet—not shown—which crosspiece is formed onto tool accommodation 12. Tool accommodation 12 is mounted within stator 51, so as to rotate, by way of rotor 52 and bearings 54. In this connection, bearings 54 are disposed within the U-shaped cross-section of stator 51, on the housing side, on outside shank 512 of stator 51. With this arrangement of bearings 54, placement of rotor 52 essentially on the outer circumference of tool accommodation 12 is possible. Furthermore, two crosspieces 14 formed on circumferentially, parallel to one another, are formed onto tool accommodation 12 in the immediate vicinity of passage 13, which crosspieces engage into corresponding grooves 510 of stator 51.

Inside shank 511 of the U-shaped cross-section of stator 51 that faces away from housing 10 is provided with windings 53 for generation of an electromagnetic field. Windings 53 are disposed in such a manner that only a narrow air gap is formed between windings 53 and rotor 52. On its side that faces tool accommodation 12, stator 51 has a projection 513 directed in the direction of the axis of rotation of tool accommodation 12, which projection extends almost all the way to the outer circumference of tool accommodation 12. The bearing shell of bearings 54 that faces housing 10 lies against projection 513 of stator 51.

The electromagnetic rotational direct drive used is indicated only with its essential components in the present case. Details of the configuration of such direct drives are sufficiently known to a person skilled in the art. The particular advantage of the arrangement of the direct drive according to the invention is due to the simpler mechanical structure. By eliminating the mechanical transmission elements used for power transformation, this direct drive is free of play. System variables such as current, power or torque, and speed or speed of rotation, can be determined directly and included in a regulation concept. This not only improves the positioning accuracy but also simplifies the regulation of this drive. Another advantage that results from the elimination of mechanical transmission elements is the freedom from maintenance that is connected with this.

The circular saw described above is only an example of a device for chip-producing machining; of course, the present invention is not restricted to whirling cutting devices. Instead, the invention extends to cover all devices with which chip-producing machining of work pieces in the form of pipes and rods via whirling methods can be achieved. These also include devices for thread whirling, for example.

Accordingly, while only a few embodiments of the present invention have been shown and described, it is obvious that many changes and modifications may be made thereunto without departing from the spirit and scope of the invention.

What is claimed is:

1. A device for chip-producing machining of work pieces in the form of pipes and rods, using a whirling method, comprising:
a whirling unit having a housing,
an accommodation for a whirling tool having teeth on an inside, said accommodation being mounted on the whirling unit so as to rotate; and
an electromagnetic rotation direct drive connected with the whirling unit, said drive comprising a ring-shaped stator attached to the housing and having an essentially U-shaped cross-section, and a rotor being configured in the form of a ring-shaped crosspiece provided with permanent magnets, formed onto the accommodation, said rotor being mounted within the U-shaped cross-section of the stator, on a housing side,
wherein the stator is provided with a winding for generation of an electromagnetic field, on its inside shank of its U-shaped cross-section that lies opposite the housing.

2. The device according to claim 1, wherein at least one groove is introduced on the inside shank of the U-shaped cross-section of the stator, and wherein a guide crosspiece formed onto the accommodation engages said at least one groove.

3. The device according to claim 1, wherein the rotor is essentially disposed on an outer circumference of the accommodation.

4. The device according to claim 1, wherein the stator has a projection directed in a direction of an axis of rotation of the accommodation on a side of the stator that faces the accommodation, said projection extending almost all the way to an outside circumference of the accommodation.

5. The device according to claim 1 wherein the stator has at least one channel for passing coolant therethrough.

6. The device according to claim 1, wherein the accommodation of the whirling unit has indexing pins that correspond to indexing bores in the whirling tool.
